(19) United States
(12) Patent Application Publication
(10) Pub. No.: US 2008/0150707 A1
(43) Pub. Date: Jun. 26, 2008

(54) Vehicle device

(75) Inventor: Michio Shamoto, Konan-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 12/001,755

(22) Filed: Dec. 12, 2007

(30) Foreign Application Priority Data
Dec. 25, 2006 (JP) 2006-348282

(51) Int. Cl. B60Q 1/00

(52) U.S. Cl. 340/425.5

(57) ABSTRACT

A vehicle device for use in vehicle-roadside communication that communicates with a roadside device disposed on a roadside includes a radio unit for receiving an informational message from the roadside device as well as a display and a speaker for information provision. The vehicle device further includes a storage unit for storing the informational message received by the radio unit. A system controller in the vehicle device determines whether information provision condition for providing the informational message in the storage unit is met based on an information content and current condition information in the informational message received by the radio unit. When the information provision condition is determined to be met, the system controller controls the display and the speaker to cause a provision of the informational message.

### CROSS REFERENCE TO RELATED APPLICATION

This application is based on and claims the benefit of priority of Japanese Patent Application No. 2006-348282 filed on Dec. 25, 2006, the disclosure of which is incorporated herein by reference.

### FIELD OF THE INVENTION

The present disclosure generally relates to a vehicle device for use in a vehicle to provide a user with useful information.

### BACKGROUND INFORMATION

Conventionally, a vehicle device is used for vehicle-roadside communication between the vehicle device disposed on the vehicle and a roadside device disposed on a roadside of a traveling vehicle.

A certain vehicle device watches a pulling out of a card in the unit by using a card detector when a user leaves the card in the vehicle device, and provides a large warning sound from a speaker when the card is pulled out by a thief (refer to Japanese patent document JP-A-2003-132387). The vehicle device in the above patent document makes the thief run off from the vehicle without pulling out the card. Even when the card is stolen despite of the large warning sound, a radio communication unit sends theft information to a credit card issuance company, a credit card user company or a card holder's cellular phone, thereby making it possible to prohibit the use of the card in an earlier stage. That is, the vehicle device claims to protect the user from card theft when the card is left on the vehicle.

In terms of leaving the card on the vehicle, some of the vehicle devices provide card insertion warning for warning the user of an absence of the card from the vehicle device when the vehicle device receives a signal from an “advance notice antenna,” a “notification antenna,” or other antennas prior to an entrance into an electronic toll collection (ETC) gate. In addition, in case where the card is pulled out from the vehicle device in a service area (SA), a parking area (PA) or the like in an expressway, the antenna described above is disposed at an exit from the SA/PA for insertion warning. Further, in a dedicated short range communication (DSRC), an information provision scheme that received information is accumulated (or retained) for provision at an appropriate timing according to display position information determined by an information provider side is under consideration. In this scheme, the information is determined to be provided for the user based on an information provision position that is centered around a point defined by predetermined coordinates and a direction (i.e., a bearing) of the vehicle.

However, the vehicle device described above has following problems. That is, the information provision scheme that uses various antennas as described above determines whether required information for ETC payment is existing at hand based on the information acquired-from the vehicle device through the radio communication at every instance of communication. That is, whether an ETC card is correctly inserted is determined communication by communication. Therefore, the warning for calling an attention is provided immediately after the communication with the roadside device. However, in the above warning provision scheme, card insertion is determined only when the vehicle device communicates with the roadside device, thereby making it necessary to have may antennas installed along the road. In addition, the antenna is usually installed over the road due to a communication range requirement, thereby restricting warning provision timing only for traveling vehicles. As a result, the user, that is, a driver of the vehicle, is distracted from driving operation to check an insertion condition of the card, which may lead to an unsafe operation.

Further, when stored information is used, entering into an information provision area (a circular area centered around a point that has predetermined coordinates) triggers information notification, thereby serving the information notification to general public in the provision area. That is, for example, when the information provision area is set at the SA/PA, the information notification is served for the user before he/she pulls out the card from the vehicle device, thereby causing a goal of card insertion confirmation prior to a departure from the SA/PA unachievable.

### SUMMARY OF THE INVENTION

In view of the above and other problems, the present invention provides a vehicle device having vehicle-roadside communication capability to communicate with a roadside device along a road for providing a user of useful information without triggering user operation in a traveling vehicle.

The vehicle device of the present invention provides information received from a roadside device for the user based on information provision requirement and information contents in the received information and an agreement of the requirement with current vehicle condition.

More practically, the vehicle device for use in vehicle-roadside communication that enables communication with a roadside device disposed on a roadside includes: a current condition detector capable of acquiring current condition information indicative of a current condition of a vehicle; a receiver capable of receiving informational message that is transmitted from the roadside device; a storage unit capable of storing information message received by the receiver; a calculation unit that calculates a fulfillment of an information provision condition for causing a provision of the informational message; an information unit capable of informing the informational message; and a control unit capable of causing the information unit to inform the informational message upon detecting the fulfillment of the information provision condition. The informational message at least includes an informational content and an information provision requirement for causing the provision of the informational message, and the calculation unit determines the fulfillment of the information provision condition with the current condition in the current condition information based on the informational content and the information provision requirement in the informational message and the current condition information detected by the current condition detector.

The vehicle device and the roadside device of the present invention configured as described above provides the user with useful information through only a few roadside devices at an entrance/exit of, for example, a service area, a parking area or the like. Therefore, the number of antennas disposed along a road is reduced and the user is prevented from being distracted due to an avoidance of unnecessary information provision.

### BRIEF DESCRIPTION OF THE DRAWINGS

Other objects, features and advantages of the present invention will become more apparent from the following detailed description made with reference to the accompanying drawings, in which:

FIG. 1 shows a block diagram of an in-vehicle device in an embodiment of the present invention;

FIGS. 2A and 2B show diagrams of information respectively describing items to be provided from a roadside device and items stored accumulatively in the in-vehicle device;

FIGS. 3A and 3B show illustrations of information provision area respectively illustrating a relationship between the information provision area and a vehicle and a relationship between the information provision area and an expressway;

FIG. 4 shows a flowchart of a user attention drawing process; and

FIG. 5 shows a flowchart of an information storage process.

### DETAILED DESCRIPTION

Embodiments of the present disclosure are described with reference to the accompanying drawings.

The embodiment which the present invention is applied to as follows is described with a drawing. In addition, the form of the enforcement of the present invention can adopt various kinds of forms without being limited to the following embodiment as far as it pertains to the technical field of the present invention.

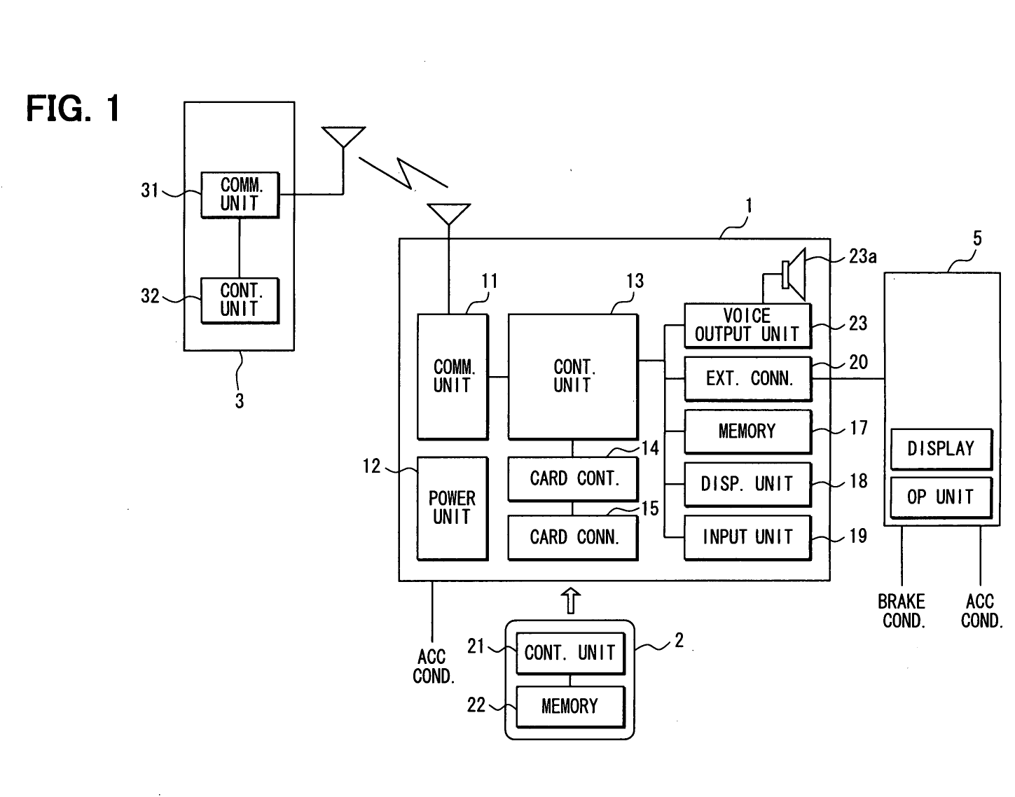

An embodiment of an in-vehicle device 1 of the present embodiment is described with reference to FIG. 1. FIG. 1 is a block diagram showing an in-vehicle device 1, a multifunctional IC card (an IC card hereinafter) 2, and a roadside device 3. (Configuration of In-vehicle device 1 and roadside device 3) The in-vehicle device 1 has a communication unit 11, a power unit 12, a control unit 13, a card controller 14, a card connector 15, a memory 17, a display unit 18, an input unit 19, an external connector 20, and a voice output unit 23. The device 1 is an in-vehicle device for road-vehicle-communication use disposed on a vehicle, and communicates with the roadside device 3 installed in the neighborhood of the travel course of the vehicle, as shown in FIG. 1.

The communication unit 11 consists of by a well-known communication circuit and an antenna. The communication unit 11 carries out wireless communication with the roadside device 3. The device 3 is, for example, a roadside device for toll collection of the electric toll collection (ETC) system (ETC payment) installed in the tollgates of the toll road, a roadside device for providing notice which is installed prior to the toll collection roadside device, a roadside device for the card verification or a roadside device for the credit payment use installed at the exits of the parking lot. The roadside device 3 consists of a well-known communication circuit and an antenna, and the device 3 includes a control unit 32 for controlling various parts of the device 3, and a communication unit 31 for communication with the in-vehicle device 1.

The roadside device for notices and the roadside device for card verification are respectively called as “a notice antenna” and “a verification antenna” in the ETC system. The roadside device for notices guides the usability of the ETC traffic lane, and the roadside device for card verification is used for providing warning for non-insertion of the ETC card. In addition, the roadside device for the credit payment set up at the exits of the parking lot is a roadside device to settle a parking fee by a credit card.

The roadside device for payment, for notices, and for card verification has a basic configuration as the roadside device (such as a control unit, a communication unit and the like), thereby having the same reference numbers. Therefore, these devices are distinguished by explanation. In other words, the device 3 is designated either as the roadside device 3 for the ETC payment, the roadside device 3 for notices, the roadside device 3 for card verification, and roadside device 3 for the credit payment.

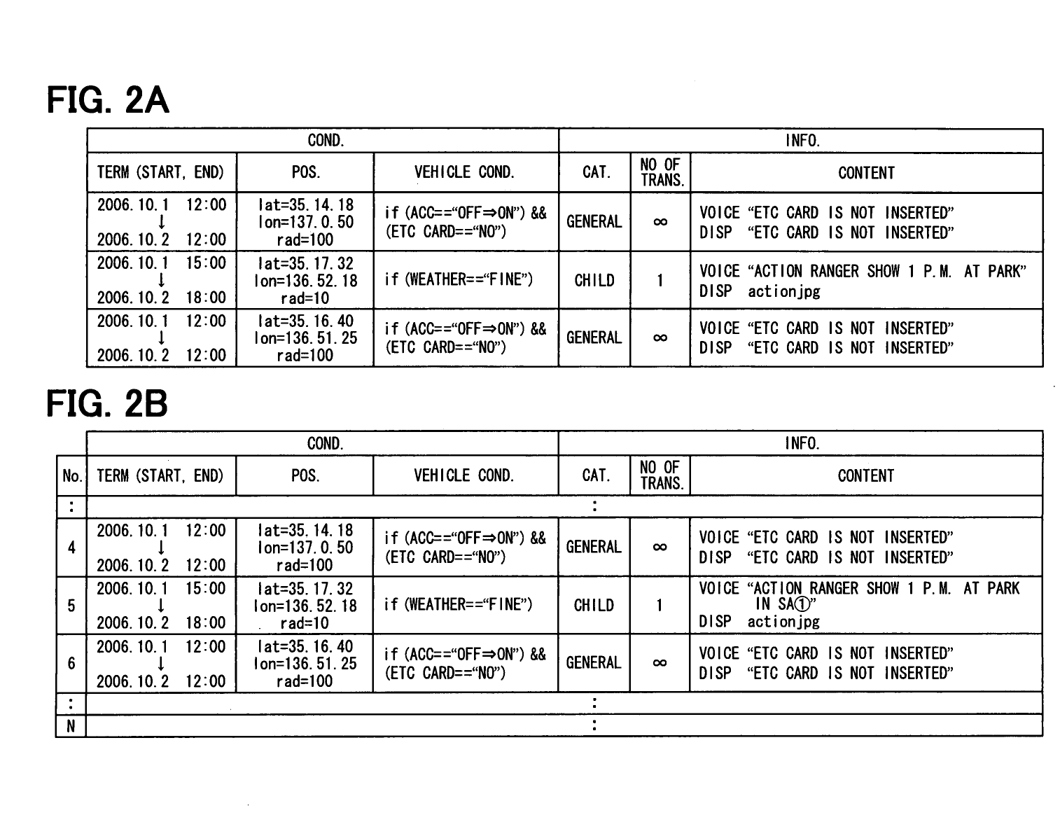

The roadside device 3 has a function to memorize information (e.g., an informational message) and a function to transmit information to be memorized. An information category, the reporting number of times (the number of times the information is provided), notice contents (information contents) and a notice requirement (an information requirement) are included in the information as exemplified in FIG. 2A. Among the above described information, for example, the notice contents are the beneficial information for a user or the warning information for a user. That is, discount guidance information to notify a discounted pricing in a store “from 15:00 to 16:00”, entertainment guidance information to notify “an ‘action mask’ comes to a child park in a specific service area (SA)/a parking area (PA) at 13:30” and ETC card non-insertion warning “an ETC card is not inserted” are provided as the informational message. In addition, as an information category, a target audience of the information or a purpose of the information is specified. That is, for example, a general public, children, relief, security, vehicle control are among others to be specified in the category column. In addition, the reporting number of times indicates information about an upper limit number of times for providing information having the specific notice contents. In addition, the notice requirement is a condition to provide information of above-mentioned notice contents, and includes information validity term (time to provide information), a reporting position (positional to provide information) and a vehicle condition (a vehicle status information). The information validity time includes a start time and an end time. In addition, latitude and longitude as well as an area radius are included in the reporting position. In addition, the state of the ignition and insertion or non-insertion of the ETC card as well as the weather are included in the vehicle condition.

The power unit 12 is connected to the in-vehicle battery which is not illustrated, and an electrical power supply is provided for each part of the in-vehicle device 1. The memory 17 consists of the nonvolatile memory such as the well-known flash memory, and is capable of storing the information that the communication unit 11 has received. In addition, the contents of the memory 17 is updated by the control unit 13 (refer to FIG. 2B).

The control unit 13 has a well-known CPU, ROM, RAM, input/output (I/O) serving as an input/output circuit and a bus line to connect those parts as well as a signal processing circuit for processing signal from an input operation and a signal output circuit for controlling the display unit 18. The CPU performs controls by using a control program memorized in ROM and RAM as well as using data. The ROM has a program storage area and a data storage area. A control program is stored in the program storage area, and the data which are necessary for the operation of the control program is stored in data storage area. In addition, the control program uses a work memory in the RAM as a working area.

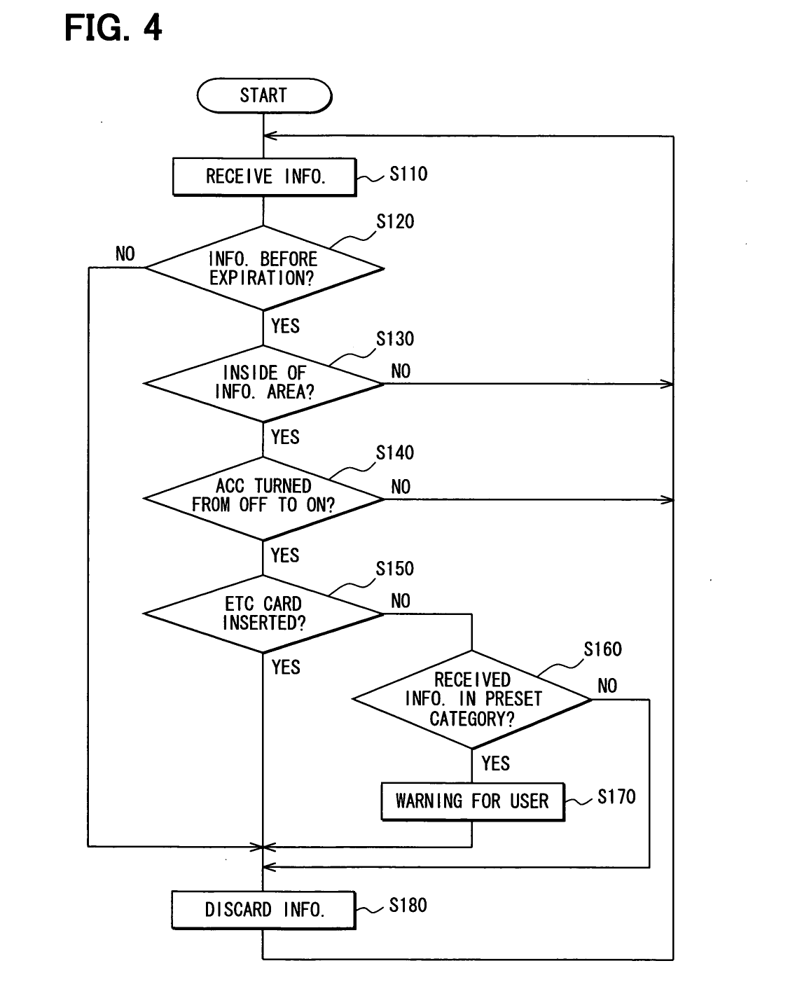

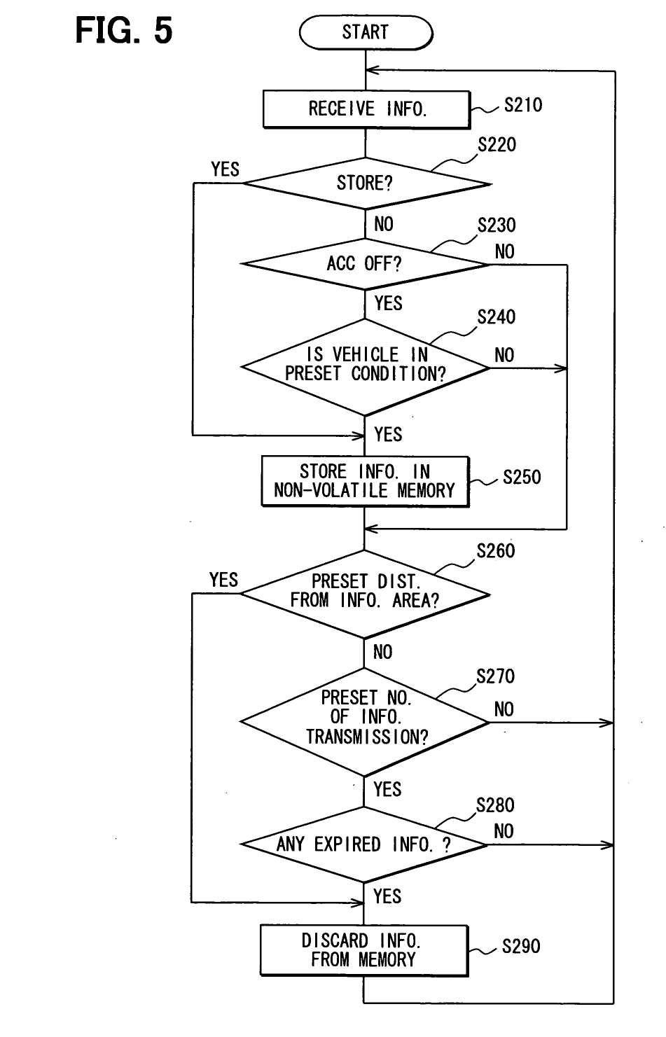

The control unit 13 is connected to the communication unit 11, the card controller 14, the memory 17, the display unit 18, the input unit 19, the external connector 20, and the voice output unit 23, and converts reception signals received by the communication unit 11 into receive data by signal processing, and also converts transmission data into transmission signal by signal processing. The communication unit 11 further performs an operation based on the transmission/reception data and the data retrieved from the memory 17, and performs an initial setting processing (writing setup information) of the ETC in-vehicle device, a fee payment processing in the ETC system, a user attention drawing processing (refer to FIG. 4), and an information storage processing (refer to FIG. 5). In addition, the explanation of the details of the initial setting processing of the ETC device and the fee payment processing of in the ETC system is omitted due to the employment of the well-known art. Further, the user attention drawing processing and the information storage processing are described later. Furthermore, various processes are carried out with the information of the IC card (the information that is required for ETC payment processing) that is input through the card controller 14.

Further, the ON/OFF state of the ignition switch is detected by the control unit 13. Furthermore, the control unit 13 controls the display unit 18 and the voice output unit 23 for providing information when, based on notice contents, the information provision requirement and current condition information included in the information from the roadside device 3, the information provision condition for providing information in the memory 17 is found out to be fulfilled after determination.

The card controller 14 reads and writes information of the IC card 2 through the card connector 15. That is, the card controller 14 serves as a card reader/writer. The card connector 15 is configured to have the IC card 2 inserted and pulled out therein/therefrom, and the card controller 14 is configured to be capable of detecting insertion and pull-out of the IC card 2 into/from the connector 15.

The display unit 18 and the voice output unit 23 are devices for providing a user with the information such as conditions of the devices and/or the payment of the ETC system. In addition, a speaker 23a has a function to provide a sound played back by the voice output unit 23.

Various buttons and other parts are provided on the input unit 19 for an input of various instructions and data from the user. The external connector 20 is used for data communication to other external equipment 5 disposed on the vehicle such as navigation apparatuses and the like, and is capable of retrieving the current condition information indicative of the current condition of the vehicle from the external equipment 5. In addition, the current condition information includes current time information indicative of the current time, current position information indicative of the current position of the vehicle and current status information indicative of the current status of the vehicle.

### (Configuration of IC Card 2)

The IC card 2 is described next. The IC card 2 includes a control unit 21 which exchanges data with the card controller 14 through the card connector 15 of the in-vehicle device 1 and controls a memory 22, and the memory 22 that consists of non-volatile storage device for storing/retrieving information, the card connector 15 of in-vehicle device 1.

The memory 22 stores a program for plural application processes including ETC payment processing, parking lot payment processing and the like. In other words, for example, the IC card 2 serves as a multiple functions card that has, in a single card, credit payment functions equipped in a so-called credit card in addition to ETC payment functions equipped in a so-called ETC card.

In addition, the memory 22 stores contract information for the credit card including the expiration date of the contract of the credit card and the like, the payment information for paying toll of toll roads. In addition, the memory 22 stores IC card identification information (card ID) for identifying the IC card 2 in advance.

For example, when ETC payment processing is carried out, the information retrieved from the IC card 2 is transmitted to the roadside device 3 as a part of the in-vehicle device information, and gate passage time as well as tollgate information including a gate number for identifying a gate and use history information such as a vehicle type transmitted in response to the transmitted information is stored in the memory 22.

When the IC card 2 is inserted in the in-vehicle device 1, information in the IC card is retrieved to in-vehicle device 1. The information is transmitted as the in-vehicle device information together with the information pre-registered in the in-vehicle device 1 at the time of wireless communication. The in-vehicle device 1 performs wireless communication with the roadside device 3 for toll payment disposed at an entrance/exit of toll roads for calculating the toll.

On the other hand, when the in-vehicle device 1 performs wireless communication with the roadside device 3 for notices that is mentioned above, the availability of the ETC traffic lane is guided to the user through the display unit 18, the voice output unit 23 and the speaker 23a based on the information acquired from the roadside device 3. In addition, card information is transmitted to the roadside device 3 for card verification when the in-vehicle device 1 communicates with the roadside device 3 for card verification through wireless communication.

In addition, when the in-vehicle device 1 communicates with the roadside device 3 for the credit payment set up at the exits of the parking lot through wireless communication, the in-vehicle device 1 acquires the card information that it is required for the credit payment from the IC card 2 according to instructions from the roadside device 3 of the credit payment. The retrieved card information is transmitted to the roadside device 3 for the credit payment through wireless communication for performing credit payment processing.

In the above description, the parts of the in-vehicle device 1 may be associated to language in claims in the following manner. That is, the communication unit 11 can conceptually be equivalent to a receiver. The memory 17 can conceptually be equivalent to a non-volatile memory. The control unit 13 can conceptually be equivalent to a calculation unit, a control unit, and a first/second/third/fourth memory control units. The IC card controller 14 can conceptually be equivalent to a card type detection unit. The card connector 15 can conceptually be equivalent to a card insertion slot. The external connector 20 can conceptually be equivalent to a current condition detector.

The user attention drawing processing conducted by the control unit 13 of the in-vehicle device 1 is described next with reference to a flowchart in FIG. 4.

When the power is supplied to the in-vehicle device 1, this processing is carried out independently from other processing. At first, the information from the roadside device 3 is received through the communication unit 11 (S110). The information validity term included in the received information is referred to in succession, and whether the validity term of the information is before expiration date is determined (S120). When the information is not determined before the expiration date, that is, when the validity term is determined to have been expired (S120:NO), the information is discarded (S180) and the process returns to S110. On the other hand, when the information is determined to be before expiration date (S120:YES), the process proceeds to S130.

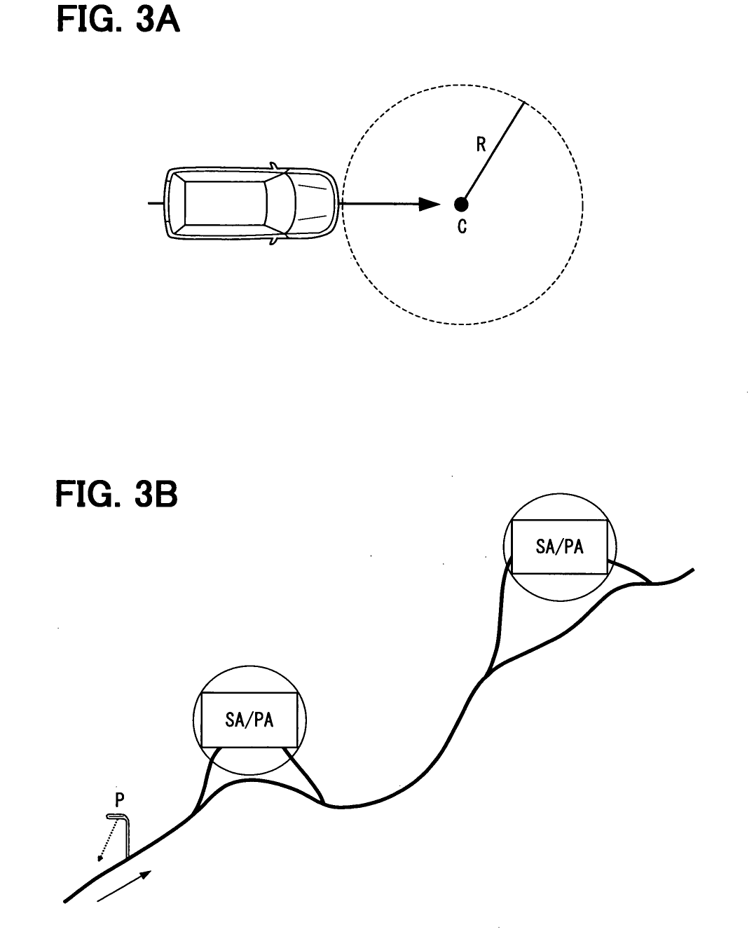

In S130, an information reporting position included in the received information is referred to, and whether the vehicle is in an information provision area (with a center C and a radius R in FIG. 3A) is determined based on information on the current position of the vehicle (S130, refer to FIGS. 3A/3B). When it is determined that the vehicle is not in the provision area (S130:NO), the information is discarded (S180), and the process returns to S110. On the other hand, when it is determined that the vehicle is in the provision area (S130:YES), the process proceeds to S140.

In S140, the vehicle status information acquired from the vehicle is referred to, and whether an accessory switch (ACC: i.e., automobile ignition setting) is changed from OFF to ON is determined (S140). When it is determined that ACC is not changed from OFF to ON (S140:NO), the information is discarded (S180), and the process returns to S110. On the other hand, when it is determined that ACC is changed from OFF to ON (S140:YES), the process proceeds to S150.

In S150, whether an ETC card is inserted is determined (S150). When it is determined that the ETC card is inserted (S150:YES), the information is discarded (S180), and the process returns to S110. On the other hand, when it is determined that the ETC card is not inserted (S150:NO), the process proceeds to S160.

In S160, it is determined whether the information received earlier is the information of a predetermined category (S160). More practically, whether the information provision condition is fulfilled is determined, based on the notice contents and the information provision requirement in the information transmitted from the roadside device 3 to the communication unit 11 and the current condition information acquired from the external equipment 5 or the like through the external connector 20. More practically, the state of the ignition turning from OFF to ON is determined that the information provision condition is fulfilled. When it is determined that the information is not the information of the predetermined category (a predetermined condition) (S160:NO), the information is discarded (S180), and the process returns to S110. On the other hand, attention drawing (i.e., warning) and information provision for the user are carried out by controlling the display unit 18 and the voice output unit 23 (S170) when it is determined that the information is the information of the predetermined category (a predetermined condition) (S160:YES). Then, the information is discarded (S180), and the process returns to S110.

The information storage process by the control unit 13 in the in-vehicle device 1 is described next with reference to a flowchart in FIG. 5.

When the power is supplied to the in-vehicle device 1, this processing is carried out independently from other processing. At first, the information in the roadside device 3 is received through the communication unit 11 (S210). The information validity term included in the received information is referred to in succession, and whether the information should be immediately stored is determined (S220). More practically, the information validity term included in the information is referred to, and it is determined not to immediately store the information when an end time of the validity term has passed. When it is determined that information should be stored immediately (S220:YES), the process proceeds to S250 that is to be mentioned later. On the other hand, when it is determined that the information is not stored immediately (S220:NO), the process proceeds to S230.

In S230, the vehicle status information acquired from the vehicle is referred to, and it is determined whether ACC is turned OFF (S230). When it is determined that ACC is not turned OFF (S230:NO), the process proceeds to S260 that is to be mentioned later. On the other hand, when it is determined that ACC is turned OFF (S230:YES), the process proceeds to S240.

In S240, whether the vehicle status condition is fulfilled is determined. In this case, the state of the ignition of the vehicle is determined to fulfill the status condition when the ignition is turned from OFF to ON. When it is determined that the vehicle status condition is not fulfilled (S240:NO), the process proceeds to S260 that is to be mentioned later. On the other hand, when it is determined that the vehicle status condition is fulfilled (S240:YES), the information is stored in the memory 17 (S250) and the process proceeds to S260.

In S260, whether the current position of the vehicle is distant at least by a predetermined distance from the information provision area is determined (S260). When it is determined that the current position of the vehicle is at least distant by the predetermined distance from the provision area (S260:YES), unnecessary information is discarded from the memory 17 (S290). Then, the process returns to S210. On the other hand, when it is determined that the current position of the vehicle is not distant from the information provision area by the predetermined distance (S260:NO), the process proceeds to S270.

In S270, whether the number of times of information provision (i.e., how many times the information has been provided) exceeds a predetermined number of information provision is determined. When it is determined that the number of times of the information provision is not greater than the predetermined number (S270:NO), the process returns to S210. On the other hand, when it is determined that the number of times of the information provision is equal to or greater than the predetermined number (S270:YES), the process proceeds to S280.

In S280, whether there is the information whose validity term has expired in the memory contents of the memory 17 is determined. More practically, the validity term of the information in the memory 17 is referred to, and whether the validity term has expired is determined. When it is determined there is no information that has the expired validity term in the memory contents of the memory 17 (S280:NO), the process returns to S210. On the other hand, unnecessary information is discarded from the memory 17 (S290) when it is determined that there is the information that has the expired validity term in the memory contents of the memory 17 (S280:YES). Then, the process returns to S210.

The above embodiment has the following advantageous effects.

(1) According to the configuration of the in-vehicle device 1 in the above embodiment, the information to be provided for the user is received from the roadside device 3, is stored temporarily in the memory 17 and is actually provided for the user as a result of processing to draw user's attention when the information provision condition included in the information itself is fulfilled (refer to S160/S170 in FIG. 4). In this manner, the number of the roadside devices 3 are reduced for providing the information for the user in a timely manner. That is, for the user entering/exiting to/from the service area/parking area, useful information is appropriately provided without causing a user operation in the traveling vehicle.

(2) In addition, when an information condition is determined to be fulfilled by turning OFF the ignition key, the information is provided for the user from the speaker 23a and/or the display 18. Therefore, the information is used to provide service area specific information for the user. That is, when a parameter for limiting the display time of the information is used, a limited time discount price information in a certain service area/parking area can be provided for the user.

(3) Further, by using the information provision requirement that includes time information, position information and vehicle information such as the ignition condition, the condition of the vehicle is specifically identified for providing specific information. That is, by using the time information in the requirement, information provision for the user at an unintentional timing is prevented. For example, the time information for information provision is specified as 14:30 to 16:00 regarding information on a limited time discount price sale that is to be held at a shop along a travel route during 15:00 to 16:00, unnecessary information provision for the vehicle that enters the information provision area at 12:00 is prevented. The unnecessary information provision for the vehicle entering the area at 16:10 is also prevented. In this case, the time information may also be specified as “night time” or the like. The vehicle condition such as the ignition condition may further incorporated in the provision condition for identifying an appropriate condition of the vehicle and the user.

(4) Furthermore, the information is saved in the memory 17 when certain vehicle condition is fulfilled (S240/S250). In this manner, storage space in the memory 17 is saved due to the prioritization of the content of the information. That is, the limited storage space of the memory 17 is effectively used by discarding the information of lower priority. For example, the information regarding rain detection is specified to be saved in the memory 17, only the rain information is effectively stored in the memory 17. Further, when the condition for saving the information in the memory 17 is specified as a condition that the vehicle is in an expressway, or a condition that the ETC is used at an entrance of an expressway, the unnecessary storage of the information regarding the use of the ETC by the user who is not traveling on an expressway is prevented.

(5) Furthermore, the in-vehicle device 1 is configured to provide the information when the ignition of the vehicle is turned ON. In this manner, the provision of the stored information for the user is performed at an appropriate time such as at a time of starting the engine, or at a time of releasing a parking brake. For example, ETC card insertion warning is provided before starting the vehicle by using the above information provision scheme. In this case, the user listens the warning message in a safe condition for inserting the ETC card because the vehicle is not yet been started. In addition, by determining that the information provision condition is partially fulfilled upon detection of turning ON of the ignition, the information is provided only for the user who is going to start a travel, thereby preventing the uncomfortableness and/or unsafeness of the user due to unnecessary information provision. Further, the information is acquired and stored in the in-vehicle device 1 beforehand, various antennas such as the notice antenna and/or the verification antenna disposed at every SA/PA can be saved, thereby enabling a reduction of the number of the antennas and the roadside devices 3.

In addition, the above-mentioned information is saved in the memory 17, thereby making it possible to provide the information for the user whenever the provision requirement is fulfilled. The storage of the information to the memory 17 may be carried out whenever information is received, or only when shutdown of the power supply of in-vehicle devices 1 such as the ACC OFF is detected. In addition, a timing for storing the information in the memory 17 may specifically be specified.

(6) Furthermore, expired information in terms of information validity term is discarded for saving the memory area after examining the validity term in the information (S120/S180). That is, the unnecessary information is discarded according to the validity term specified in the information.

(7) Furthermore, expiration of the validity term of the information in the memory 17 is examined, and the expired information is discarded from the memory 17 (S280/S290). In this case, when the number of times of the actual provision of the information stored in the information itself is referred to in comparison to the predetermined number of provision, the predetermined number of provision may be set beforehand, or may be provided from the roadside device 3, or may be determined according to the priority of the information. In this manner, the information can be managed regardless of expiration date. In addition, memory capacity to memorize information can be reduced.

(8) Furthermore, the information provision position specified in the received information is referred to in comparison to the current vehicle position for determining the discard of the information (S130, refer to FIGS. 3A-3B). That is, when the vehicle is not in the information provision area (S130:NO), the information is discarded. In this manner, the memory capacity to memorize information can be reduced.

(9) Furthermore, when the card insertion is examined (S150), the result is utilized either for the discard of the received information or for the waning provision for the user. That is, for example, when the ETC card is detected, the received information such as the notice (i.e., the warning) to encourage the insertion of the card for the user is discarded without provision. When the card is not detected, the warning is provided for the user only after determining that the predetermined condition is met (S160/S170). In this manner, the user is warned only when the card is not inserted or when another card such as DSRC card is inserted in the insertion slot. Therefore, unintended information provision for the user is prevented by, for example, incorporating the condition that an entrance through the ETC gate at an entrance of an expressway.

Although the present invention has been fully described in connection with the preferred embodiment thereof with reference to the accompanying drawings, it is to be noted that various changes and modifications will become apparent to those skilled in the art.

For example,

(1) In the above embodiment, the requirement for information provision at least includes time information (information provision time, that is, information validity term), position information (information provision positional) and vehicle condition (vehicle status information), and the current condition information includes the current time information, current position information and current condition information. However, the requirement may only include the time and position information without including the vehicle condition, and the current condition information may only include the current time and position information without including the current condition information.

(2) The vehicle condition such as the ignition condition in the information provision requirement may be replaced with other conditions such as information from, for example, a luminometer, barometer, thermometer, rain sensor, windshield wiper, blinker, light, steering wheel steerage corner, speed, shift lever, foot brake, parking brake, tire air pressure, air-conditioner switch, and other sensor information, as well as ETC gate passage histories and the like. In this manner, the information is also appropriately provided for the user according to the condition of the vehicle. The examples of the information provision for certain occasions are as follows. That is, when the requirement that the information should be provided only when the light is turned off is transmitted to the in-vehicle device 1 from the roadside device 3, a notice for the user (i.e., attention drawing, or information provision) is provided for the vehicle that does not turn the light on at a proximity of a tunnel in a specific time slot of the day. Further, when the requirement that the information should be provided for the vehicle that is traveling at a certain speed or the faster at a time when the steering wheel is rotated to a certain angle or more in the rain is transmitted, the information is provided only when the travel of the vehicle is unsafe due to the rain. Furthermore, when a combination of requirements such as the requirement that the vehicle is traveling in an expressway after passing through the ETC entrance, the requirement that the ignition is turned on and the requirement that the ETC card is not inserted, is transmitted from the roadside device 3, the absence of the ETC card insertion is appropriately noticed for the user.

(3) Further, when the vehicle is traveling at or under a certain speed, the information may be provided for the user. More practically, the speed information from the external equipment 5 may be used to determine whether the speed of the vehicle is at or under a certain speed for the fulfillment of the condition that the received information is in a certain category (S160). In this manner, the warning for the user is provided for the user from the speaker 23a or from the display 18 only when the vehicle is traveling at or under a certain speed for the safety of the travel. Further, the information provision condition may be determined to be partially fulfilled when the traveling speed of the vehicle is at or under a certain speed if other conditions are incorporated for determination of fulfillment.

(4) Furthermore, the information received at a local road may be provided for the user when the vehicle is traveling in the expressway. More practically, when the information is configured to include the position of the roadside device 3 that transmits the information, the provision of the information according to the predetermined category is determined based on the position information of the roadside device 3, which is determined to be in the local road or in the side road by referring to map information or the like (S160). In this case, the information may be determined as partially met when the position of the roadside device 3 is in the local road or side road by adding additional conditions. In this manner, the information is appropriately provided for the user, that is, mis-notification for the user is prevented due to the spillover of the signal from the notice antenna or from the verification antenna, or the reduction of the number of the roadside devices 3 are achieved.

(5) Furthermore, in response to the information transmitted from the roadside device 3, transmission of detailed information in the current communication or in the subsequent communication may be requested. More practically, when the information from the roadside device 3 is received in S110 for the user attention drawing processing through the communication unit 11, the control unit 13 transmits a request for relevant information regarding the received information by controlling the communication unit 11 to the roadside device 3 which is an origin of transmission of the information. The relevant information includes the detailed information. In this manner, the information provision for the user is supplemented by the detailed information, thereby enabling fine-tuned information provision services.

(6) The user attention drawing processing may be performed through other media instead of the speaker 23a or the like. That is, for example, the control unit 13 may use AM/FM radio, TV, vehicular devices or the like for providing information for the user. In this manner, DSRC information delivery may be utilized for a jump to a certain other medium. That is, for example, when the highway information is available through AM radio (1620 Hz: a dedicated traffic information radio frequency in Japan) in a certain broadcasting area during the travel on the expressway, the frequency information may be delivered in advance. In this manner, the AM radio tuned to the provided frequency is turned on when the vehicle enters into the broadcasting area for the improved convenience of the user. Further, the broadcasting timing may be provided as the time information that is tagged to the traffic information so that only the required information for the user such as the up/down traffic specific information is provided for the user. The user may also choose from ON/OFF settings of the traffic information. TV broadcasting may be controlled in the same manner.

(7) Furthermore, the information may be selectively provided for the user based on the information category specified in the information. In this manner, the information is provided in a fine-tuned manner.

Such changes and modifications are to be understood as being within the scope of the present invention as defined by the appended claims.

What is claimed is:

1. A vehicle device for use in vehicle-roadside communication that enables communication with a roadside device disposed on a roadside, the vehicle device comprising:
a current condition detector capable of acquiring current condition information indicative of a current condition of a vehicle;
a receiver capable of receiving informational message that is transmitted from the roadside device;
a storage unit capable of storing information message received by the receiver;
a calculation unit that calculates a fulfillment of an information provision condition based on the current condition in the current condition information for causing a provision of the informational message;
an information unit capable of informing the informational message; and
a control unit capable of causing the information unit to inform the informational message upon detecting the fulfillment of the information provision condition,
wherein the informational message at least includes an informational content and an information provision requirement for causing the provision of the informational message, and
the calculation unit determines the fulfillment of the information provision condition with the current condition in the current condition information based on the informational content and the information provision requirement in the informational message and the current condition information detected by the current condition detector.

2. The vehicle device of claim 1,
wherein the information provision requirement at least includes provision time information that defines time of provision of the informational message and provision position information that defines a position of provision of the informational message, and
the current condition information includes current time information indicative of current time and current position information indicative of a current position of the vehicle.

3. The vehicle device of claim 1,
wherein the information provision requirement at least includes provision time information that defines time of provision of the informational message, provision position information that defines a position of provision of the informational message and provision condition information that defines a vehicle condition at a time of provision of the informational message, and
the current condition information includes current time information indicative of a current time, current position information indicative of the current position of the vehicle and current status information indicative of a current status of the vehicle.

4. The vehicle device of claim 3,
wherein the provision condition information includes information on a change of an ignition condition of the vehicle, and
the current status information in the current condition information includes information on a change of an ignition condition of the vehicle.

5. The vehicle device of claim 4 further comprising:
a non-volatile memory capable of storing the informational message; and
a first memory control unit capable of causing the non-volatile memory to store the informational message,
wherein the calculation unit determines the fulfillment of the information provision condition based on the information on the change of the ignition condition of the vehicle included in the information provision requirement as the provision condition information and the information on the change of the ignition condition of the vehicle included in the current condition information as the current status information, and
when the fulfillment of the information provision condition is determined by the calculation unit, the first memory control unit causes the non-volatile memory to store the informational message.

6. The vehicle device of claim 5,
wherein the information provision requirement includes the fulfillment of the information provision condition in a case where the ignition condition of the vehicle turns from OFF to ON,
the calculation unit determines that the information provision condition is at least partially in a fulfillment when the information on the change of the ignition condition of the vehicle as the current status information in the current condition information indicates that the ignition condition has turned from OFF to ON.

7. The vehicle device of claim 6,
wherein the control unit controls the information unit to inform the informational message when the calculation unit determines that the information provision condition is in a fulfillment based on the information on the change of the ignition condition of the vehicle as the current status information in the current condition information.

8. The vehicle device of claim 1 further comprising:
a second memory control unit capable of erasing the informational message from the storage unit,
wherein the informational message includes valid term information indicative of a valid term of the informational message, and
the second memory control unit erases the informational message from the storage unit when the valid term information in the informational message in the storage unit is found out to indicate that the valid term has been expired.

9. The vehicle device of claim 1 further comprising:
a third memory control unit capable of erasing the informational message,
wherein the informational message includes provision number information indicative of the number of provision of the informational message, and
the third memory control unit erases the informational message from the storage unit when the provision number information in the informational message in the storage unit is found out to indicate that the informational message has been provided equal to or more than a predetermined number of times.

10. The vehicle device of claim 1 further comprising:
a fourth memory control unit capable of erasing the informational message from the storage unit,
wherein the informational message includes an information provision area information indicative of an area where the informational message is provided, and
the fourth memory control unit erases the informational message from the storage unit when the information provision area information is found out to indicate that the vehicle is not in the information provision area.

11. The vehicle device of claim 1 further comprising:
a card insertion slot capable of having a card inserted therein; and
a card type detection unit capable of determining that the card inserted in the card insertion slot is a DSRC card,
wherein the control unit controls the information unit to provide a replacement warning message indicative of an encouragement that the DSRC card should be replaced with an ETC card when the card in the card insertion slot is determined to be the DSRC card.

12. The vehicle device of claim 3,
wherein the provision condition information includes information on an upper speed limit,
the current status information in the current condition information includes information on a vehicle speed, and
the calculation unit determines that the information provision condition is at least partially in a fulfillment when the vehicle speed as the current status information in the current condition information is equal to or smaller than the upper speed limit of the provision condition information.

13. The vehicle device of claim 1,
wherein informational message includes installation position information indicative of a position of installation of the roadside device, and
the calculation unit determines that the information provision condition is at least partially in a fulfillment when the position of installation of the roadside device in the installation position information is found out to be on one of a local road and a side road.

14. The vehicle device of claim 1 further comprising:
a transmitter capable of transmitting a request message to the roadside device when the receiver receives the informational message,
wherein the request message requests a transmission of relevant information relevant to the informational message to the receiver from the roadside device that has transmitted the informational message.

15. The vehicle device of claim 1,
wherein the control unit utilizes an external configuration of the vehicle device to provide the informational message when the information provision condition is determined to be in a fulfillment by the calculation unit.
